(19) United States
(12) Patent Application Publication
(10) Pub. No.: US 2015/0012960 A1
(43) Pub. Date: Jan. 8, 2015

(54) SERVER APPARATUS AND METHOD FOR SWITCHING TRANSMITTING SYSTEM

(71) Applicant: Kabushiki Kaisha Toshiba, Tokayo (JP)

(72) Inventor: Kiyotaka Tsuji, Tokyo (JP)

(21) Appl. No.: 14/498,608

(22) Filed: Sep. 26, 2014

Related U.S. Application Data
(63) Continuation of application No. 13/614,245, filed on Sep. 13, 2012, now abandoned.

(30) Foreign Application Priority Data
Sep. 15, 2011 (JP) 2011-202324

(51) Int. Cl. H04N 21/222; H04N 21/24

(52) U.S. Cl. CPC H04N 21/222; H04N 21/2404
USPC 725/116

(57) ABSTRACT

A server apparatus is provided with: a pair of unit parts which can be used for a double system containing an active system and a spare system; a pair of main control parts which can be used for the double system containing an active system and a spare system, and can control the pair of the unit parts and can monitor each other. The main control part used as an active system includes a detection means and a system switch means. When the detection means detects that one of the processing units contained in the unit part used as the active system is broke down, the system switch means changes the broken processing unit from the active system to the spare system, and changes the processing unit which is paired with the broken processing unit from the spare system to the active system.

### CROSS-REFERENCE TO RELATED APPLICATION(S)

This application is based upon and claims the benefit of priority from the prior Japanese Patent Application No. 2011-202324, filed on Sep. 15, 2011, the entire contents of which are incorporated herein by reference.

### FIELD

An embodiment relates to a server apparatus and a method for switching transmitting systems.

### BACKGROUND

Generally, in a program sending-out system in a broadcasting station, in order to improve the reliability of broadcast by preventing troubles, such as a broadcasting stop, the redundancy which made the transmitting system double composition is performed.

The program sending-out system has a video server which records the contents of broadcast programs in order to prepare for broadcasting. Specifically, the video server has two systems used for an active system and a spare system. Two video servers used as the active system and the spare system are equipped with front switches, main control parts, control switches, storages, etc., respectively. In the storages of these two video servers, the same contents files created by changing compression coded data, which is made by compressing and coding a baseband video signal of the broadcast program, into files, are stored respectively.

Thus, by constituting a system with double composition including the active system and the spare system, when failure occurs in the video server used as the active system, the video server used as the spare system is switched seamlessly to the active system, and processing can be continued.

In a prior art, for example, when some one of the processing units, such as a front switch, a main control part, and a control switch, included in the video server used as the active system, breaks down, all the processing units including a normal unit are switched to the video server used as the spare system.

However, in switching the system as above, instantaneous interruptions occur in all the processing units, and thereby communication quality degrades. In switching the system, by the time all the processing units of the video server used as the spare system can operate as the active system, long time is needed.

### BRIEF DESCRIPTION OF THE DRAWINGS

FIG. 1 is a block diagram showing the composition of a program sending-out system according to an embodiment;

FIG. 2 is a block diagram showing the composition of a decoding device;

FIG. 3 is a block diagram showing an example of operation in the case of using a unit of a first system as an active system;

FIG. 4 is a block diagram showing an example of operation in the case of using a unit of a second system as the active system;

FIG. 5 is a functional block diagram showing the functional composition of a main control part;

FIG. 6 is a block diagram showing operation of a first failure example;

FIG. 7 is a block diagram showing operation of a second failure example;

FIG. 8 is a block diagram showing operation of a third failure example; and

FIG. 9 is a block diagram showing parallel operation of both systems.

### DETAILED DESCRIPTION

A server apparatus according to an embodiment, includes: a pair of unit parts which can be used for a double system containing an active system to perform playback processing of contents of a broadcast program and a spare system to be used for a spare of the active system, and each unit part including a plurality of processing units; and a pair of main control parts which can be used for the double system containing the active system and the spare system, can control the pair of the unit parts, respectively, and can monitor each other; wherein the main control parts includes a detection means which detects that one of the processing units included in the unit part used as the active system or the main control part used as the active system is broken down; and when one of the processing units included in the unit part used as the active system or the main control part used as the active system is broken down, a system switching means which switches the processing unit which is paired with the processing unit broken or the main control part which is paired with the main control part broken from the spare system to the active system.

A method for switching a transmitting system according to the embodiment, includes the step of detecting that between a pair of unit parts which can be used for a double system containing an active system to perform playback processing of contents of a broadcast program and a spare system to be used for a spare of the active system and each unit part including a plurality of processing units, one of processing unit included in the unit part used as the active system is broken, or that between a pair of main control parts which can be used for the double system containing the active system and the spare system, can control the pair of unit parts, and can monitor each other, the main control part used as the active system is broken; a first switching which switches the processing unit broken from the active system to the spare system and switches the processing unit which is paired with the processing unit broken from the spare system to the active system when it is detected that one of the processing units contained in the unit part used as the active system is broken; and a second switching which switches the main control part broken from the active system to the spare system and switches the main control part which is paired with the main control part broken from the spare system to the active system when it is detected that the main control part used as the active system is broken.

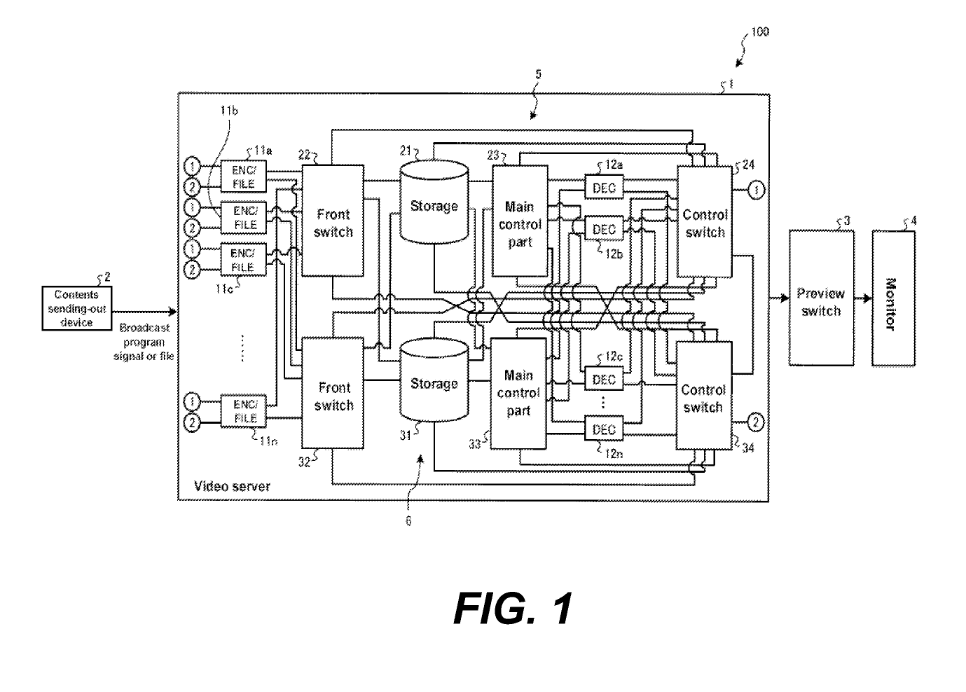

FIG. 1 is a block diagram showing the composition of program sending-out system 100 according to one embodiment. As shown in FIG. 1, the program sending-out system 100 is provided with a video server 1, a contents sending-out device 2, a preview switch 3, and a monitor 4. The video server 1 is a server apparatus used for playback processing for the contents of a broadcast program.

The contents sending-out device 2 is a sending-out device for the contents of a broadcast program, and is, for example, plural television cameras, plural video tape recorders and the like which are installed in a studio and the like. The contents sending-out device 2 sends a broadcast program signal (a baseband video signal) or a file which is the contents of the broadcast program to the video server 1.

The video server 1 is provided with encoding/file-making parts (hereafter, they are called as ENC/FILEs.) 11a-11n, storages 21, 31, and decoding devices (hereafter, they are called as DECs.) 12a-12n. ENC/FILEs 11a-11n carries out compression coding of the baseband video signal inputted from the contents sending-out device 2 to convert the baseband video signal into a coded video data, or performs file processing to the file inputted from the contents sending-out device 2. The file processing performs to analyze and to check the contents of the file. The storages 21, 31 store the compression coded data or the processed file as a contents file. In addition, the DECs 12a-12n decode the compression coded data of the contents file read from the storages 21, 31 into an usual baseband video signal and output the baseband video signal.

The preview switch 3 selects one DEC among the DECs 12a-12n to thereby select the baseband video signal and outputs the baseband video signal selected to the monitor 4. The monitor 4 receives the baseband video signal which the preview switch 3 outputs, and displays an image.

Next, the video server 1 will be explained in detail. The video server 1 has two systems which are a first system and a second system. As shown in FIG. 1, the video server 1 has a pair of unit parts 5, 6 which contain various kinds of processing units, respectively on a mother board built in. The unit part 5 and the unit part 6 can be used for the double system containing an active system and a spare system. The active system performs playback processing of contents of a broadcast program and the spare system is used for a spare of the active system. In addition, the video server 1 has a pair of main control parts 23, 33 on the mother board. The main control parts 23, 33 can also be used for the double system containing the active system and the spare system. The first system has the unit part 5 and the main control part 23, and the 2nd system has the unit part 6 and the main control part 33. The unit part 5 of the first system and the unit part 6 of the second system are controllable by the main control part 23 of the first system and the main control part 33 of the second system. In addition, the main control part 23 and the main control part 33 can be monitored mutually.

The unit part 5 of the first system is provided with the storage 21, the front switch 22, the control switch 24, and the like as processing units. The unit part 6 of the second system is also provided with the storage 31, the front switch 32, the control switch 34 and the like as processing units. In addition, the ENC/FILEs 11a-11n and the DECs 12a-12n are the processing units contained in the unit part 5 of the first system, or the unit part 6 of the second system.

The storages 21, 31 store respectively identical contents files created by changing the compression coded data or the like, in which the baseband video signal of broadcast program is compressed and coded, into a file. The storages 21, 31 store the identical contents files by copying a contents file, such as compression coded data recorded on the storage used as the active system, to the storage used as the spare system.

The main control part 23 of the first system is a microcomputer, and is provided with a CPU (Central Processing Unit) which controls each part collectively, a ROM (Read Only Memory) which stores fixed data of a program and the like beforehand, a RAM (Random Access Memory) which functions as a work areas and the like to store various data rewritably, etc. The main control part 33 of the second system, as well as the main control part 23 of the first system, is a microcomputer provided with a CPU, a ROM, and a RAM.

In addition, the main control part 23 of the first system and the main control part 33 of the second system are provided with L2 switches (layer 2 switches), respectively. According to directions from an external control apparatus (not shown) which instruct to send out the contents of the broadcast program, the main control parts 23, 33 choose the storage from which the contents file is read out between the storage 21 of the first system and the storage 31 of the second system, and choose the DEC to which the contents file is sent out among the DECs 12a-12n, using the L2 switches.

The ENC/FILEs 11a-11n are connected to the front switch 22 of the first system and the front switch 32 of the second system so as to output the data to both the front switch 22 of the first system and the front switch 32 of the second system.

The front switch 22 of the first system and the front switch 32 of the second system are provided with L2 switches (layer 2 switches), respectively. The front switches 22, 32 choose the storage which stores the contents file which is the compression coded data generated by the ENC/FILEs 11a-11n, or the file processed from the storages 21, 31 using the L2 switches.

The storage 21 of the first system is connected to the front switch 22 of the first system, the front switch 32 of the second system, the main control part 23 of the first system and the main control part 33 of the second system, and is accessible from both systems.

The storage 31 of the second system, as well as the storage 21 of the first system, is connected to the front switch 22 of the first system, the front switch 32 of the second system, the main control part 23 of the first system and the main control part 33 of the second system, and is accessible from both systems.

The DECs 12a-12n are connected to the main control part 23 of the first system and the main control part 33 of the second system so as to receive the data from both the main control part 23 of the first system and the main control part 33 of the second system.

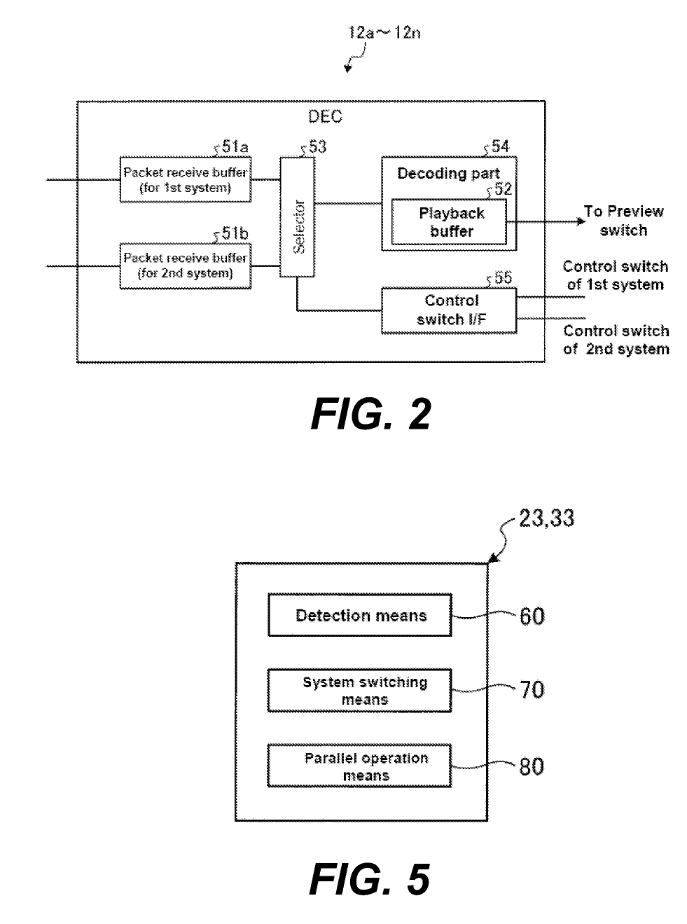

Here, the DECs 12a-12n are explained in detail. FIG. 2 is a block diagram showing the composition of the DEC 12a-12n. When the DEC 12a-12n is roughly divided, it has two kinds of buffers. One is a packet receive buffer 51a, 51b which receives a packet and stores and holds the packet received. The other is a playback buffer 52 which stores decoded playback data (a baseband video signal) temporarily. The packet receive buffer 51a is provided for the first system, and is connected to the main control part 23. The packet receive buffer 51b is provided for the second system, and is connected to the main control part 33. A control switch I/F 55 is connected to the control switch 24 of the first system and the control switch 34 of the second system. The control switch I/F 55 monitors the control switch 24 of the first system and the control switch 34 of the second system, and controls a selector 53.

For example, in the case where the main control part 23 of the first system and the main control part 33 of the second system transmit the contents of the same broadcast programs from the storage 21 of the first system and the storage 31 of the second system to the same DEC 12a-12n, respectively, when the active system is the first system, in the DEC 12a-12n, the selector 53 chooses the compression coded data of the contents file from the packet receive buffer 51a of the first system. While the decoding part 54 decodes the selected compression coded data into the usual baseband video signal and stores the baseband video signa in the playback buffer 52 temporarily, the decoding part 54 outputs the baseband video signal in the playback buffer 52 to the monitor 4 via the preview switch 3. Thereby, the monitor 4 displays an image of the contents of the played-back broadcast program.

According to the DEC 12a-12n of such composition, even if the main control part 23 of the first system or the control switch 24 of the first system breaks down at the time of playback in the case where the active system is the first system, the DEC 12a-12n distinguishes the system of failure by the control switch I/F 55, and changes the selector 53 in an instant. Thereby, the contents of the broadcast program is played back from the compression coded data of the contents file stored in the packet receive buffer 51b of the second system. When the second system is used as the active system, the same processing as above-mentioned can be performed by operation contrary to the above-mentioned operation.

The control switch 24 of the first system constitutes control channels among the front switch 22 of the first system, the storage 21 of the first system, the main control part 23 of the first system, the ENC/FILEs 11a-11n, and the DECs 12a-12n. The control switch 24 of the first system exchanges the directions which instruct to record the contents of the broadcast program on the storage 21, the directions which instruct to send out the contents of the recorded broadcast program to the DEC 12a-12n, and the directions which instruct to send out the contents of the broadcast program to the ENC/FILE 11a-11n again, among the processing units. In FIG. 1, the control switch 24 of the first system and the ENC/FILEs 11a-11n are connected mutually with lines shown by (1).

In addition, the control switch 24 of the first system is connected also with the front switch 32 of the second system, the storage 31 of the second system and the main control part 33 of the second system.

The control switch 34 of the second system, as well as the control switch 24 of the first system, constitutes control channels among the front switch 32 of the second system, the storage 31 of the second system, the main control part 33 of the second system, the ENC/FILEs 11a-11n and the DECs 12a-12n. The control switch 34 of the second system exchanges the directions which instruct to record the contents of the broadcast program on the storage 31, the directions which instruct to send out the contents of the recorded broadcast program to the DEC 12a-12n and the directions which instruct to send out the contents of the broadcast program to the ENC/FILE 11a-11n again, among the processing units. In FIG. 1, the control switch 34 of the second system and the ENC/FILEs 11a-11n are connected mutually with lines shown by (2).

In addition, the control switch 34 of the second system is connected also with the front switch 22 of the first system, the storage 21 of the first system and the main control part 23 of the first system.

Furthermore, the control switch 24 of the first system and the control switch 34 of the second system are connected each other. Accordingly, the main control part 23 of the first system and the main control part 33 of the second system can be mutually monitored via the control switch 24 of the first system and the control switch 34 of the second system.

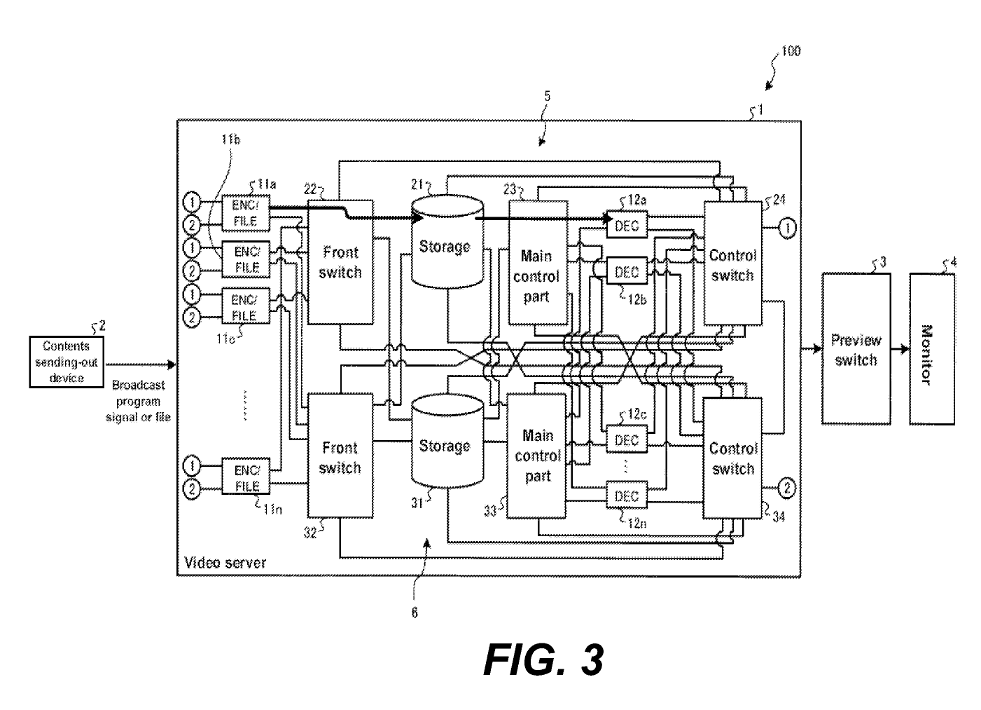

Next, referring to FIG. 3, the operation is explained in the case where the unit part 5 of the first system and the main control part 23 of the first system are used as the active system and the unit part 6 of the second system and the main control part 33 of the second system are used the spare system. Note that the contents are sent out in the course shown as a solid line in FIG. 3.

As shown in FIG. 3, the baseband video signal or the file sent out from the contents sending-out device 2 is inputted into the ENC/FILE 11a-11n. The ENC/FILE 11a-11n performs file processing to the file in the case of the file. The ENC/FILE 11a-11n performs compression coding to the baseband video signal to thereby convert the baseband video signal into the coded video data in the case of the baseband video signal.

Note that regarding the ENC/FILE which is used as an input system, the main control part 23 of the first system which is the active system monitors the ENC/FILEs 11a-11n via the control switch 24 of the first system, and assigns one of the ENC/FILEs 11a-11n which is not used as the input system. In addition, use assignment of the ENC/FILEs 11a-11n may be determined beforehand.

The contents file which is the compression coded data generated by the ENC/FILE 11a-11n or the file processed by the ENC/FILE 11a-11n is inputted into the front switch 22 of the first system, and is outputted to the target storage 21 of the first system between the storages 21, 31 by the L2 switch of the front switch 22.

The storage 21 of the first system stores the contents file generated by changing the compression coded data and the like, which is produced by compression coding the baseband video signal of the broadcast program, into the file. As mentioned above, the contents file stored in the storage 21 of the first system is copied to the storage 31 of the second system.

After that, when required, the directions which instruct to send out the contents of the target broadcast program reaches the main control part 23 of the first system and the main control part 33 of the second system from the external control apparatus (not shown). Then, the main control part 23 sends out the target contents file to a target DEC among the DECs 12a-12n from the storage 21 of the first system with the L2 switch of the main control part 2. That is, the DEC 12a-12n specified by the external control apparatus (not shown) is assigned as an output system. In this case, the main control part 33 sends out the same contents file as the target content file to the target DEC from the storage 31 of the second system with the L2 switch of the main control part 33.

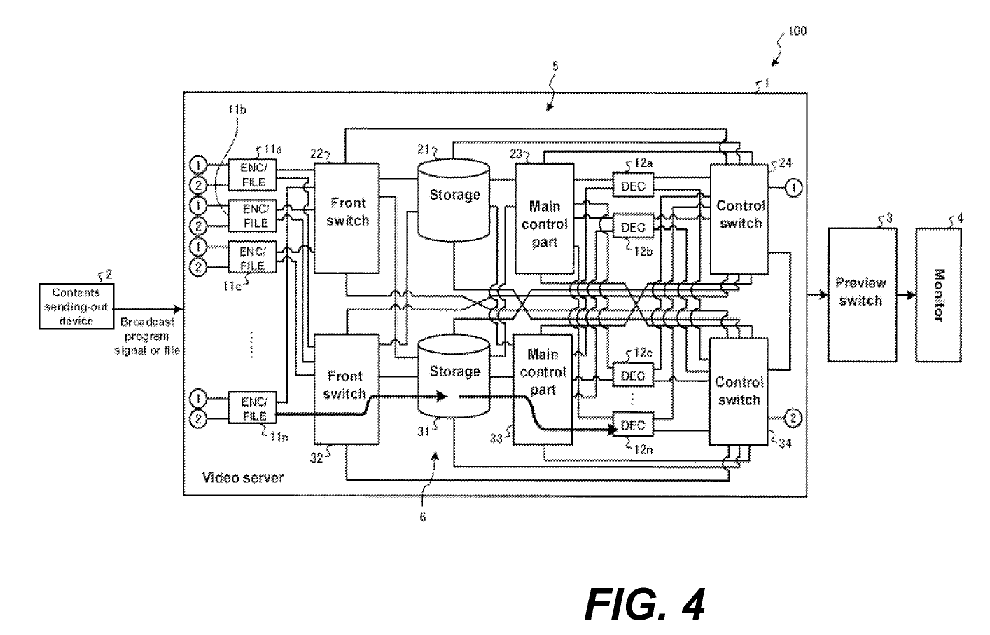

As shown in FIG. 4, also when the unit part 6 of the second system and the main control part 33 of the second system are used as the active system, the video server 1 performs the same operation as above-mentioned operation. Note that the content of the broadcast program is sent out in a course shown as a solid line in FIG. 4. When using the first system as the active system, the second system operates as the spare system, and when using the second system as the active system, the first system operates as the spare system.

Next, the operation which changes the broken processing unit or the broken main control part from the active system to the spare system, and the operation which changes the processing unit or the main control part which are paired with the broken one from the spare system to the active system in the case where one of the processing units (the front switch, the control switch etc.) or the main control part of the system which works as the active system is broken, is explained.

Such switching operation is realized by the operation of the main control part 23 of the first system and the main control part 33 of the second system. In each of the main control part 23 of the first system and the main control part 33 of the second system, specifically, when the program in the ROM starts up, the CPU operate as a detection means 60 and a system switching means 70, as shown in FIG. 5. Operation which changes the broken processing unit or the broken main control part from the active system to the spare system, and the operation which changes the processing unit or the main control part which are paired with the broken one from the spare system to the active system, are realized by the detection means 60 and the system switching means 70.

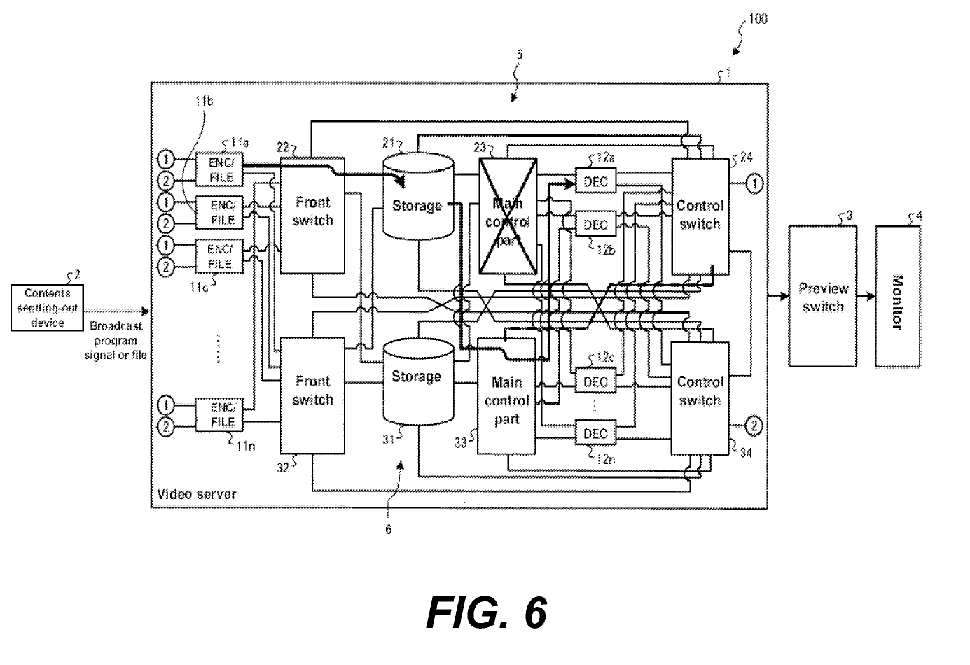

First, an operation when the main control part 23 of the first system which is the active system breaks down is explained as a first failure example, referring to FIG. 6.

As shown in FIG. 6, when the main control part 23 of the first system which is the active system breaks down, the detection means 60 of the main control part 33 of the second system detects that the main control part 23 of the first system broke down. Then, the system switching means 70 of the main control part 33 of the second system changes the main control part 23 of the first system from the active system to the spare system, and changes the main control part 33 of the second system from the spare system to the active system. That is, when the main control part 23 of the first system breaks down, the main control part 33 of the second system will become the active system and the main control part 23 of the first system will become the spare system. Note that the front switch 22 of the first system, the storage 21 of the first system and the control switch 24 of the first system keep their operations as they do. By doing in this way, the control switch 24 of the first system constitutes control channels among the front switch 22 of the first system, the storage 21 of the first system, the main control part 33 of the second system, the ENC/FILEs 11a-11n, and the DECs 12a-12n.

As a broken line shows in FIG. 6, by reconstructing the control channel between the control switch 24 of the first system and the main control part 33 of the second system, a control communication therebetween is attained. The contents of the broadcast programs stored in the storage 21 of the first system are sent out to the DECs 12a-12n in the course shown as a solid line in FIG. 6.

Since the main control parts 23, 33 are connected with the storages 21, 31 and the DECs 12a-12n, switching the main control parts is performed in an instant. Switching the the front switch 22 of the first system and the control switch 24 of the first system is not performed. It is sufficient that switching the systems is performed only on the main control part 23 of the first system which is a failure part and the main control part 33 of the second system. In addition, since the playback is continued using the data stored in the packet receive buffer 51b of the DEC 12a-12n, communicative failure time can be held down to the shortest.

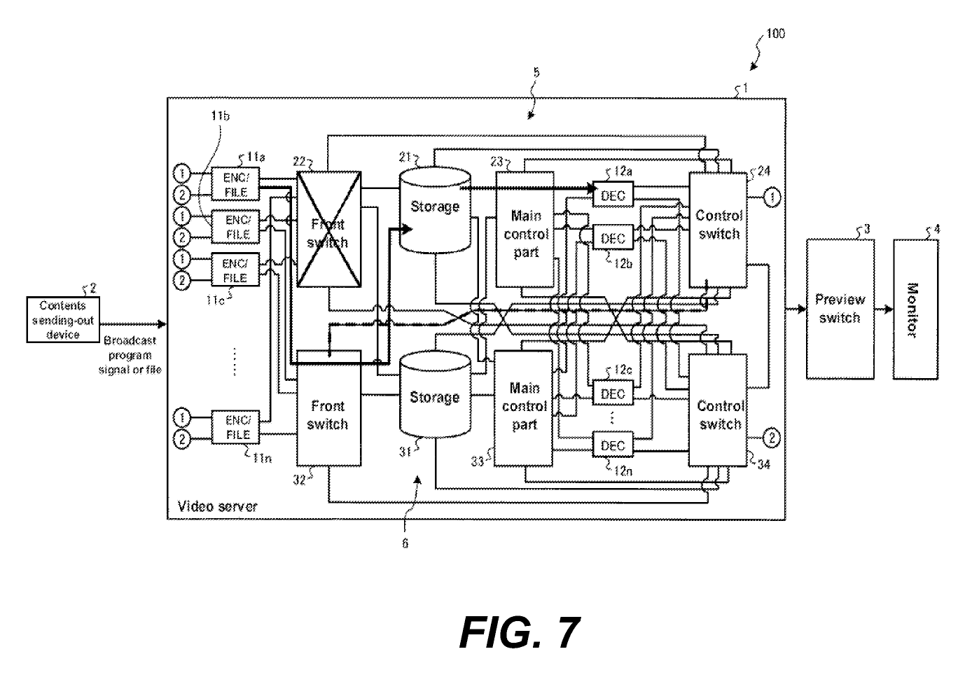

Next, an operation when the front switch 22 of the first system which is the active system breaks down is explained as a second failure example with reference to FIG. 7.

As shown in FIG. 7, when the front switch 22 of the first system which is the active system breaks down, the detection means 60 of the main control part 23 of the first system detects that the front switch 22 of the first system broke down via the control switch 24 of the first system. Then, the system switching means 70 of the main control part 23 of the first system changes the front switch 22 of the first system from the active system to the spare system, and changes the front switch 32 of the second system from the spare system to the active system. That is, when the front switch 22 of the first system breaks down, the front switch 32 of the second system will become the active system, and the front switch 22 of the first system will become the spare system. Note that the storage 21 of the first system, the main control part 23 of the first system, and the control switch 24 of the first system keep their operations as they do. By doing in this way, the control switch 24 of the first system constitutes control channels among the front switch 32 of the second system, the storage 21 of the first system, the main control part 23 of the first system, the ENC/FILEs 11a-11n, and the DECs 12a-12n.

As a broken line shows in FIG. 7, by reconstructing the control channel between the control switch 24 of the first system and the front switch 32 of the second system, a control communication therebetween is attained. Since recording operation does not carry out in real time, recording at the time of failure is rerun in a course shown by a solid line in FIG. 7.

According to this embodiment, the change of an active system and the spare system is carried out only about a broken processing unit and a processing unit which is paired with the broken processing unit at the time of failure. From this, even if the front switch 22 of the first system breaks down during the playback by the DEC 12a-12n via the main control part 23 of the first system from the storage 21 of the first system, a played back image is not disturbed.

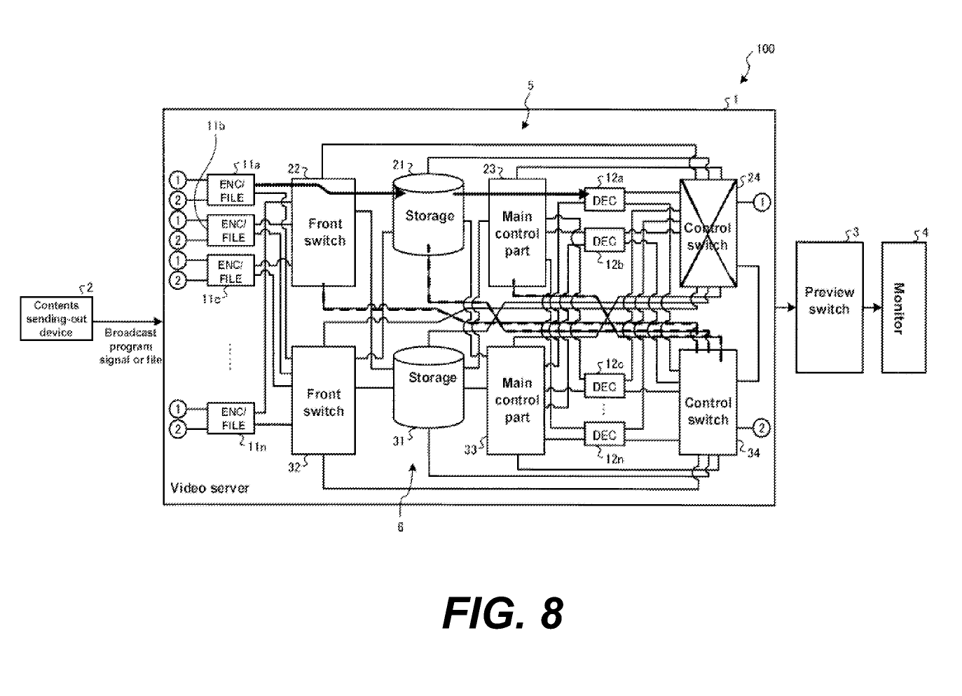

Next, an operation when the control switch 24 of the first system which is the active system breaks down is explained as a third failure example with reference to FIG. 8.

As shown in FIG. 8, when there is no response from either the ENC/FILE 11a-11n, the front switch 22 of the first system, the storage 21 of the first system, the DEC 12a-12n and the control switch 34 of the second system to survival monitor signals from the main control part 23 of the first system, the detection means 60 of the main control part 23 of the first system detects that the control switch 24 of the first system which is the active system broke down. Then, the system switching means 70 of the main control part 23 of the first system changes the control switch 24 of the first system from the active system to the spare system, and changes the control switch 34 of the second system from the spare system to the active system. That is, when the control switch 24 of the first system breaks down, the control switch 34 of the second system will become the active system and the control switch 24 of the first system will become the spare system. Note that the front switch 22 of the first system, the storage 21 of the first system, and the main control part 23 of the first system keep their operations as they do. By doing in this way, the control switch 34 of the second system constitutes control channels among the front switch 22 of the first system, the storage 21 of the first system, the main control part 23 of the first system, the ENC/FILEs 11a-11n, and the DECs 12a-12n.

As a broken line shows in FIG. 8, by reconstructing the control channels among the control switch 34 of the second system, the front switch 22 of the first system, the storage 21 of the first system, and the main control part 23 of the first system, control communications among them are attained. Note that control channels about the ENC/FILEs 11a-11n and the DECs 12a-12n are reconstructed similarly.

In the first to third failure examples shown in FIGS. 6 to 8 mentioned above, the first system is the active system and the second system is the spare system when the video server starts up. However, when the second system is the active system and the first system is the spare system, operation opposite to the above-mentioned operation is performed.

Thus, according to this embodiment, the video server 1 is provided with a pair of the unit parts which can be the double system containing the active system and the spare system, and a pair of the main control parts which can be used for a double system including the active system and the spare system. Each unit part contains a plurality of processing units. A pair of the main control parts can control a pair of the unit parts, and can monitor each other. When detecting that the processing unit included in the unit part used as the active system broke down, the main control part used as the active system, or the main control part used as the spare system changes the broken processing unit from the active system to the spare system, and changes the processing unit which is paired with the broken processing unit from the spare system to the active system. When detecting that the main control part used as the active system was broke down, the main control part of the spare system changes the broken main control part from the active system to the spare system, and changes the main control part used as the spare system from the spare system to the active system.

Thereby, when one of the processing units or the main control parts of one system used as the active system is break down, only an unusual processing unit or an unusual main control part is changed from the active system to the spare system, and the processing unit which is paired with the unusual processing unit or the main control part which is paired with the unusual main control part is changed from the spare system to the active system. The normal processing unit or the normal main control part of one system used as the active system is employed as it is. In addition, according to the embodiment, switching the transmission systems is performed in the video server 1.

Therefore, according to this embodiment, the instantaneous interruption caused by the change of the system is limited to only a specific processing unit, and deterioration of communication quality decreases. Since the change of the processing unit or the main control part is performed by reconstruction of the control channel, time until the processing unit or the main control part changed to the active system can work as the active system, that is, time until the video server 1 can carry out normal operation, can be shortened.

Note that the system switching means 70 performs exchanging the systems about the failure part (the processing unit or the main control part) at the time of failure per GOP (Group Of Pictures) of a video data. Thereby, this can prevent a screen breaking off, even when exchange of the systems about the broken processing unit or the broken main control part is performed.

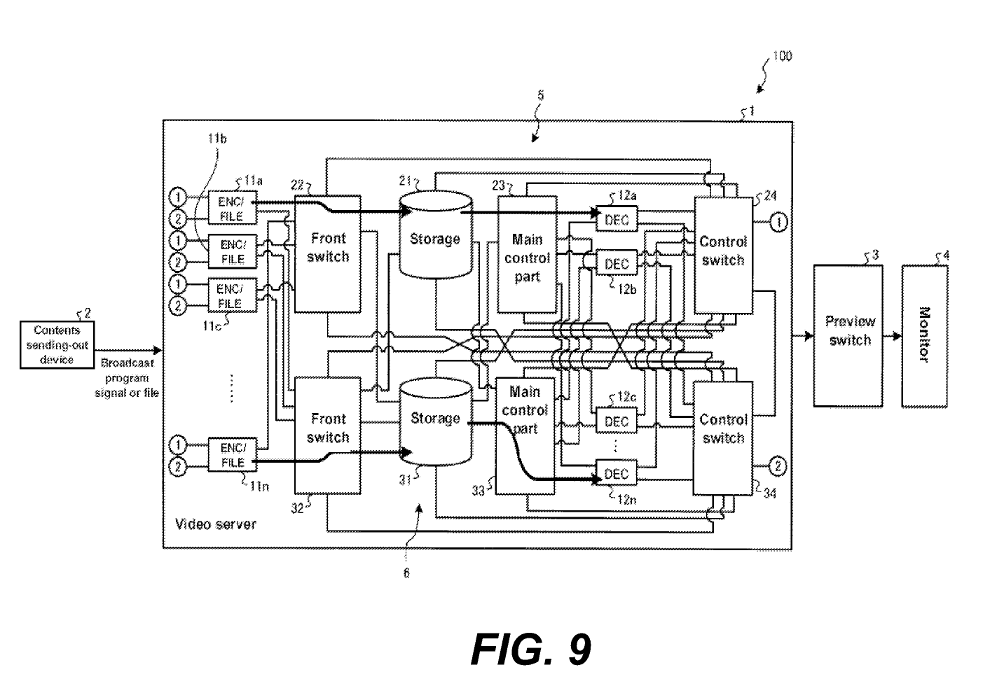

Next, another example of operation of the video server 1 is explained. Here, the case where both the first system and the second system operate in parallel is explained with reference to FIG. 9. A parallel operation of the first system and the second system is realized by the operation of the main control part 23 of the first system and the main control part 33 of the second system. More specifically, in the main control part 23 of the first system and the main control part 33 of the second system, when the program in the ROM starts, as shown in FIG. 5, the CPU functions as a parallel operation means 80 to realize the parallel operation of both the first system and the second system.

As mentioned above, wirings which connect the front switches 22, 32 and the storages 21, 31 of both systems, the main control parts 23, 33 of both systems, and the control switches 24, 34 of both systems are formed in the mother board. Therefore, when the parallel operation of both systems is directed from external control apparatus to the video server 1 at the time of starting of the server apparatus with the same configuration as the case of double system, both the systems will operate individually by the parallel operation means 80 of the main control parts 23, 33. The parallel operation of both systems can realize twice as many throughput as compared with the operation of only one system. In addition, since load is distributed to both systems without changing hardware, the number of accommodation of interface increases and processing performance also improves.

When one of the front switches 22, 32 of both systems, the main control parts 23, 33 of both systems, or the control switches 24, 34 of both systems breaks down during a parallel run, the operation can be continued by one system like the embodiment mentioned above.

The program executed by the main control part 23 of the first system or the main control part 33 of the second system of the video server 1 of this embodiment may be recorded on a recording medium which can be read by computers, such as a CD-ROM, a flexible disk (FD), a CD-R, and a DVD (Digital Versatile Disk) and may be provide by a file which is in an installable form or an executable form.

Furthermore, the program executed by the main control part 23 of the first system or the main control part 33 of the second system of the video server 1 of this embodiment may be stored on a computer connected to networks, and may be provided by downloading via the network. In addition, the program executed by the main control part 23 of the first system or the main control part 33 of the second system of the video server 1 of this embodiment may be provided or distributed via the networks, such as the Internet.

The program executed by the main control part 23 of the first system or the main control part 33 of the second system of the video server 1 of this embodiment, has module composition containing each part (the system detection means 60, the switching means 70, the parallel operation means 80) mentioned above. When the CPU as an actual hardware reads the program from the above-mentioned ROM and executes it, each part mentioned above is loaded on the RAM and the detection means 60, the system switching means 70 and the parallel operation means 80 are generated on the RAM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus, comprising:
a pair of unit parts which can be used for a double system containing an active system to perform playback processing of contents of a broadcast program and a spare system to be used for a spare of the active system, and each unit part including a plurality of processing units; and
a pair of main control parts which can be used for the double system containing the active system and the spare system, can control the pair of the unit parts, respectively, and can monitor each other; wherein
the main control parts includes
a detection means which detects that one of the processing units included in the unit part used as the active system or the main control part used as the active system is broken down; and
when one of the processing units included in the unit part used as the active system or the main control part used as the active system is broken down, a system switching means which switches the processing unit which is paired with the processing unit broken or the main control part which is paired with the main control part broken from the spare system to the active system.

2. The server apparatus according to claim 1, wherein
one of the processing units is a decoding device, and the decoding device includes:
a pair of data buffers which can be used for the double system containing the active system and the spare system and store the same contents files;
a decoding part which decodes the contents file stored in the data buffers into a baseband video signal; and
a selector which switches the data buffer used as the active system from the active system to the spare system, and switches the data buffer used as the spare system from the spare system to the active system at the time of switching from the spare system to the active system by the system switch means.

3. The server apparatus according to claim 1, wherein
one of the processing units is a control switch of a first system and a second system which constitutes a control channel between other processing units, and a pair of the control switches are connected mutually, and
the pair of the main control parts can monitor each other via the pair of the control switches.

4. The server apparatus according to claim 1, wherein
the server apparatus includes a first system and a second system,
the first system has one of the unit parts and one of main control parts,
the second system has another unit part and another main control part, and
the server apparatus further includes a parallel operation means for operating the first system and the second system in parallel.

5. The server apparatus according to claim 1, wherein
the system switching means performs switching the system broken at the time of failure per GOP (Group Of Pictures) of the contents file.

6. A method for switching a transmitting system, comprising the step of;
detecting that between a pair of unit parts which can be used for a double system containing an active system to perform playback processing of contents of a broadcast program and a spare system to be used for a spare of the active system and each unit part including a plurality of processing units, one of processing unit included in the unit part used as the active system is broken, or that between a pair of main control parts which can be used for the double system containing the active system and the spare system, can control the pair of unit parts, and can monitor each other, the main control part used as the active system is broken;
a first switching which switches the processing unit broken from the active system to the spare system and switches the processing unit which is paired with the processing unit broken from the spare system to the active system when it is detected that one of the processing units contained in the unit part used as the active system is broken; and
a second switching which switches the main control part broken from the active system to the spare system and switches the main control part which is paired with the main control part broken from the spare system to the active system when it is detected that the main control part used as the active system is broken.

7. A server apparatus, comprising:
a first system which has a unit part containing a plurality of processing units and a main control part; and
a second system which has a unit part containing a plurality of processing units and a main control part, wherein each of the processing units of the first system and each of the processing units of the second system form a pair each other, and the main control part of the first system and the main control part of the second system form a pair each other;
wherein
the processing units of the first system and the processing units of the second system can be used for a double system containing an active system which performs the playback processing of contents of broadcast program and a spare system which is used as a spare of the active system;
the main control part of the first system and the main control part of the second system can be used for the double system containing the active system and the spare system, can control the unit part of the first system and the unit part of the second system, and can monitor each other;
the main control part of the first system, when the main control part of the first system detects that one of the processing unit included in the unit part of the first system is broken, switches the processing unit broken from the active system to the spare system, and switches the processing unit which is paired with the processing unit broken from the spare system to the active system; and
the main control part of the second system, when the main control part of the second system detects that the main control part of the first system is broken, switches the main control unit of the first system from the active system to the spare system, and switches the main control part of the second system from the spare system to the active system;

8. The server apparatus according to the claim 7, wherein the first system starts up as the active system, and the second system starts up as the spare system.
